(19) United States
(12) Patent Application Publication
(10) Pub. No.: US 2024/0351195 A1
(43) Pub. Date: Oct. 24, 2024

(54) ROBOT CONTROL DEVICE AND ROBOT CONTROL METHOD

(71) Applicant: Sony Group Corporation, Tokyo (JP)

(72) Inventors: Ryo TERASAWA, Tokyo (JP); Yasuhiro MATSUDA, Tokyo (JP); Kirill VANHEERDEN, Tokyo (JP)

(73) Assignee: Sony Group Corporation, Tokyo (JP)

(21) Appl. No.: 18/574,089

(22) PCT Filed: Feb. 9, 2022
(86) PCT No.: PCT/JP2022/005211

§ 371 Date: Dec. 26, 2023

(30) Foreign Application Priority Data
Jul. 2, 2021 (JP) 2021-110817

(51) Int. Cl. B25J 9/16

(52) U.S. Cl. CPC B25J 9/1612; B25J 9/1661; B25J 9/1697

(57) ABSTRACT

A robot control device includes a gripping posture generation section that calculates a gripping posture taken upon gripping an object with a hand of a robot; an observation position generation section that calculates an observation position where the object is observable by the robot on the basis of the gripping posture calculated by the gripping posture generation section; an observation posture generation section that calculates an observation posture of the robot at the observation position on the basis of the gripping posture calculated by the gripping posture generation section and the observation position calculated by the observation position generation section; and a robot control section that controls a posture of the robot to cause the robot to take the observation posture calculated by the observation posture generation section, causes the robot in the observation posture to observe the object, and then causes the robot to approach the object.

### TECHNICAL FIELD

The present disclosure relates to a robot control device and a robot control method.

### BACKGROUND ART

There has been a robot control device that controls a robot having more redundant degrees of freedom than degrees of freedom of desired position and posture (for example, see PTL 1).

### CITATION LIST

### Patent Literature

PTL 1: Japanese Unexamined Patent Application Publication No. 2012-51043

### SUMMARY OF THE INVENTION

For example, approach may fail unless an appropriate redundant degree of freedom is set for the approach if a robot approaches a gripping target object after a hand sensor provided on a hand of the robot observes the gripping target object.

It is desirable to provide a robot control device and robot control method that make it possible to reduce a probability that approach to a gripping target object fails.

A robot control device according to an embodiment of the present disclosure includes: a gripping posture generation section that calculates a gripping posture to be taken upon gripping a gripping target object with a hand of a robot; an observation position generation section that calculates an observation position where the gripping target object is observable by the robot on the basis of the gripping posture calculated by the gripping posture generation section; an observation posture generation section that calculates an observation posture of the robot at the observation position on the basis of the gripping posture calculated by the gripping posture generation section and the observation position calculated by the observation position generation section; and a robot control section that controls a posture of the robot to cause the robot to take the observation posture calculated by the observation posture generation section, causes the robot in the observation posture to observe the gripping target object, and then causes the robot to approach the gripping target object.

A robot control method according to an embodiment of the present disclosure includes: calculating a gripping posture to be taken upon gripping a gripping target object with a hand of a robot; calculating an observation position where the gripping target object is observable by the robot on the basis of the calculated gripping posture; calculating an observation posture of the robot at the observation position on the basis of the calculated gripping posture and the calculated observation position; and controlling a posture of the robot to cause the robot to take the calculated observation posture, causing the robot in the observation posture to observe the gripping target object, and then causing the robot to approach the gripping target object.

In the robot control device or the robot control method according to the embodiment of the present disclosure, the observation position and the observation posture are calculated on the basis of the gripping posture before approaching the gripping target object.

### BRIEF DESCRIPTION OF DRAWINGS

FIG. 1 is an explanatory diagram illustrating an overview of a robot control method according to a comparative example.

FIG. 2 is an explanatory diagram illustrating an example of an issue of the robot control method according to the comparative example.

FIG. 3 is a block diagram schematically illustrating a configuration example of a robot control device according to a first embodiment of the present disclosure.

FIG. 4 is an explanatory diagram illustrating an overview of a control behavior performed by the robot control device according to the first embodiment.

FIG. 5 is a flowchart illustrating an example of the control behavior performed by the robot control device according to the first embodiment.

FIG. 6 is a flowchart illustrating a modification example of the control behavior performed by the robot control device according to the first embodiment.

### MODES FOR CARRYING OUT THE INVENTION

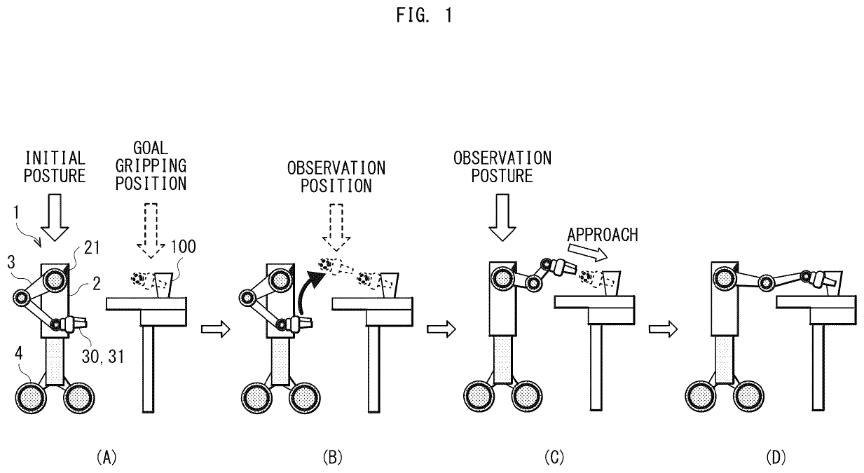

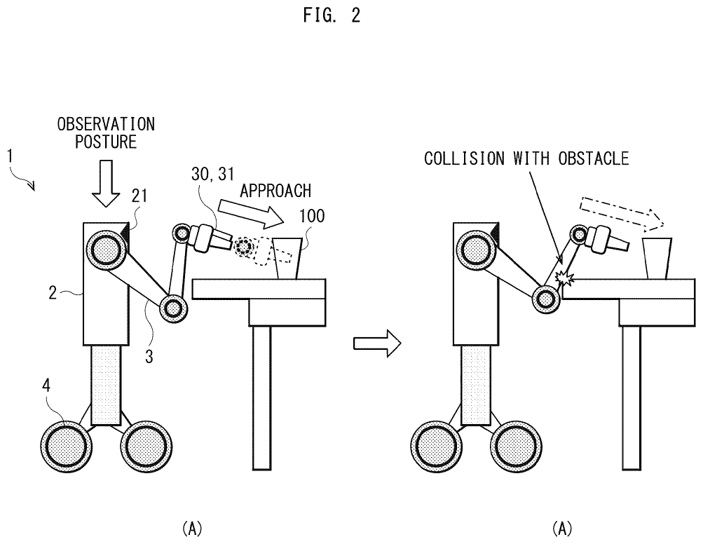

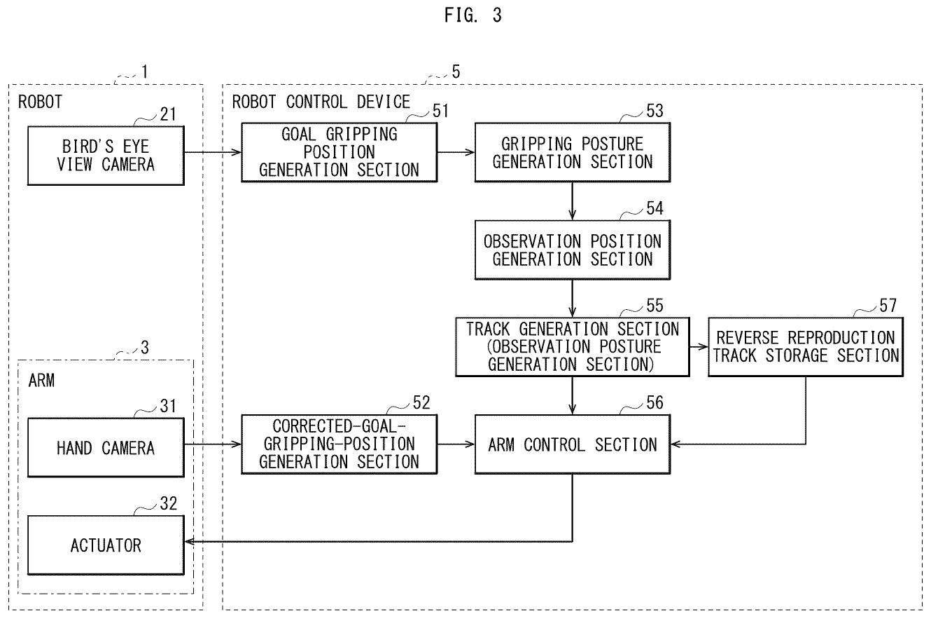

Next, with reference to drawings, details of embodiments of the present disclosure will be described. It is to be noted that the description will be given in the following order.
0. Comparative Example (FIG. 1 and FIG. 2)
1. First Embodiment (FIG. 3 to FIG. 6)
1.1. Configuration
1.2 Behavior
1.3. Modification Example
1.4 Effects
2. Other Embodiments

### 0. Comparative Example

FIG. 1 illustrates an overview of a robot control method according to a comparative example. FIG. 2 illustrates an example of an issue of the robot control method according to the comparative example.

First, an overview of a robot 1 serving as a control target of the robot control method according to the comparative example will be described. As illustrated in (A) of FIG. 1, the robot 1 includes a body 2, an arm 3, and a dolly 4. The arm 3 and the dolly 4 are attached to the body 2. The robot 1 is movable by the dolly 4 provided under the body 2.

The arm 3 is provided with a hand (hand tip) 30 on its tip. The hand 30 is provided with a hand camera 31, and is able to capture an image of (recognize) a gripping target object 100 near the hand 30. In addition, the body 2 is provided with a bird's eye view camera 21 on its upper part (head), and is able to capture a bird's eye image of its surroundings. This allows the robot 1 to perform a behavior of gripping the gripping target object 100 while recognizing (observing) the gripping target object 100 by the bird's eye view camera 21 and the hand camera 31.

When the robot 1 grips an object, in general, the robot 1 first sets a goal gripping position in an initial posture on the basis of a recognition result obtained from the bird's eye view camera 21 ((A) in FIG. 1), moves the arm 3 to a posture that satisfies the target gripping position (hereinafter, referred to as “gripping position”), and then performs a gripping behavior. At this time, there is a possibility that a position of the hand tip obtained after the movement deviates from the actual gripping position and this results in failure in gripping by influence of a measuring error of the bird's eye view camera 21 or a mechanistic error of the arm 3. As a method of avoiding the above-described issue, a control method can be considered, the control method causes the robot 1 to come closer to and observe the gripping target object 100 by using the highly accurate hand camera 31 at a position in front of the goal gripping position (hereinafter, referred to as “observation position”), and then approach the gripping target object 100 while tweaking the goal gripping position ((B) to (D) in FIG. 1).

However, when approaching the gripping target object 100 under the position control after observing the gripping target object 100 by the hand camera 31, there are possibilities that the robot 1 fails to avoid an obstacle during the approach or the robot 1 reaches a joint motion range limit and can no longer move depending on its posture at the observation position (hereinafter, referred to as “observation posture”) ((A) and (B) in FIG. 2). Examples of the disincentives include difficulty in deciding an appropriate redundant degree of freedom without high-load behavior planning in a control loop during the approach.

It is to be noted that the PTL 1 (Japanese Unexamined Patent Application Publication No. 2012-51043) proposes a technology related to decision on redundant degree of freedom and provides a system or control device that make it possible to optimally control a manipulator having a redundant degree of freedom. According to the method disclosed in the PTL 1, a behavior instruction is generated on the basis of a redundant axis angle set from a redundant angle definition table when approaching the goal position posture, and a behavior track to a goal position posture. This method is premised on an assumption that it is possible to generate the behavior track from an initial posture to the goal position posture, and this method do not assume a situation where the initial posture is a posture having a redundant degree of freedom that is hard to reach the goal position posture.

### 1. First Embodiment

By contrast to the above-described robot control method according to the comparative example, a robot control method according to a first embodiment of the present disclosure approaches the gripping target object 100 by finding the gripping posture first and then searching for the observation position and the observation posture that make it possible to easily take the gripping posture. This makes it possible to appropriately decide the redundant degree of freedom when setting the observation posture. Therefore, it is possible to prevent its approach track from unintentionally becoming complicated. In addition, this also makes it possible to check whether or not the robot 1 is able to actually reach the goal gripping position and the gripping posture that are not tweaked by the hand camera 31 before moving to the observation posture. Next, an example of a robot control device 5 that implements the robot control method according to the first embodiment of the present disclosure will be described.

### 1.1. Configuration

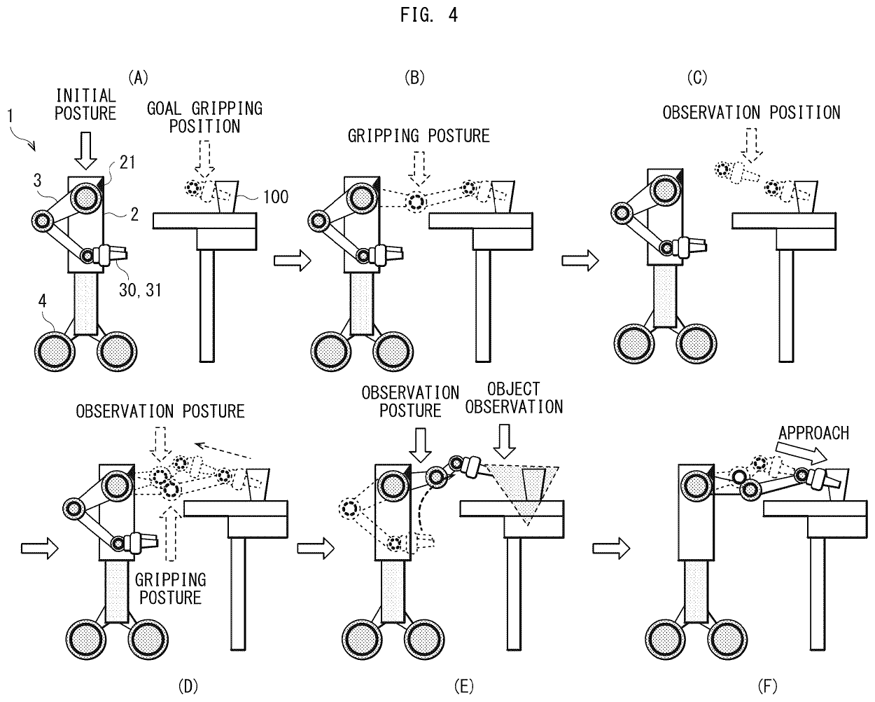

FIG. 3 schematically illustrates a configuration example of the robot control device 5 according to the first embodiment of the present disclosure. FIG. 4 illustrates an overview of a control behavior performed by the robot control device 5 according to the first embodiment.

A target of control by the robot control device 5 according to the first embodiment may be configured in a way similar to the robot 1 described above with regard to the comparative example ((A) in FIG. 4). The robot 1 has the multijoint arm 3. The arm 3 is provided with the hand 30 on its tip. The hand 30 is able to grip the gripping target object 100. The arm 3 has joint sections, each provided with an actuator 32 that is able to control positions and postures of respective parts of the arm 3 including the hand 30, on the basis of an instruction from the robot control device 5. As described above, the hand 30 is provided with the hand camera 31. The body 2 is provided with the bird's eye view camera 21 on its upper part (head). This allows the robot 1 to perform a behavior of gripping the gripping target object 100 under the control of the robot control device 5 while recognizing (observing) the gripping target object 100 by the bird's eye view camera 21 and the hand camera 31.

The bird's eye view camera 21 corresponds to a specific example of a “first sensor” according to the technology of the present disclosure. The hand camera 31 corresponds to a specific example of a “second sensor” according to the technology of the present disclosure.

The robot control device 5 according to the first embodiment includes a goal gripping position generation section 51, a corrected-goal-gripping-position generation section 52, a gripping posture generation section 53, an observation position generation section 54, a track generation section 55, an arm control section 56, and a reverse reproduction track storage section 57.

The robot control device 5 may be implemented by a computer including one or more CPUs (Central Processing Units), one or more ROMs (Read Only Memories), and one or more RAMs (Random Access Memories). In this case, processes can be performed by the respective sections of the robot control device 5 when the one or more CPUs perform a process based on a program stored in the one or more ROMs or the one or more RAMs. In addition, the processes may be performed by the respective sections of the robot control device 5 when the one or more CPUs perform a process based on a program supplied, for example, from an outside via a wired or wireless network.

The goal gripping position generation section 51 calculates a goal gripping position on the basis of information from the bird's eye view camera 21.

The corrected-goal-gripping-position generation section 52 calculates a corrected goal gripping position (hereinafter, referred to as “corrected goal gripping position”) on the basis of information from the hand camera 31.

The gripping posture generation section 53 calculates a gripping posture to be taken upon gripping a gripping target object 100 with the hand 30 of the robot 1. The gripping posture generation section 53 calculates the gripping posture that satisfies the goal gripping position calculated by the goal gripping position generation section 51. As a result, this allows the gripping posture generation section 53 to calculate the gripping posture based on sensor information from the hand camera 31.

The observation position generation section 54 calculates an observation position where the gripping target object 100 is observable by the robot 1 on the basis of the gripping posture calculated by the gripping posture generation section 53. As the observation position, the observation position generation section 54 searches for a position where the hand camera 31 provided on the hand 30 of the robot 1 is able to observe the gripping target object.

The track generation section 55 corresponds to a specific example of an “observation posture generation section” according to the technology of the present disclosure. The track generation section 55 calculates an observation posture of the robot 1 at the observation position on the basis of the gripping posture calculated by the gripping posture generation section 53 and the observation position calculated by the observation position generation section 54. For example, the track generation section 55 calculates the observation posture by calculating a track from the gripping posture calculated by the gripping posture generation section 53 to the observation position calculated by the observation position generation section 54. As the track from the gripping posture to the observation position, the track generation section 5 may calculate a track that allows the hand camera 31 to continuously observe the gripping target object 100 from the gripping posture to the observation position (a track that allows the gripping target object 100 to stay in a field of view of the hand camera 31).

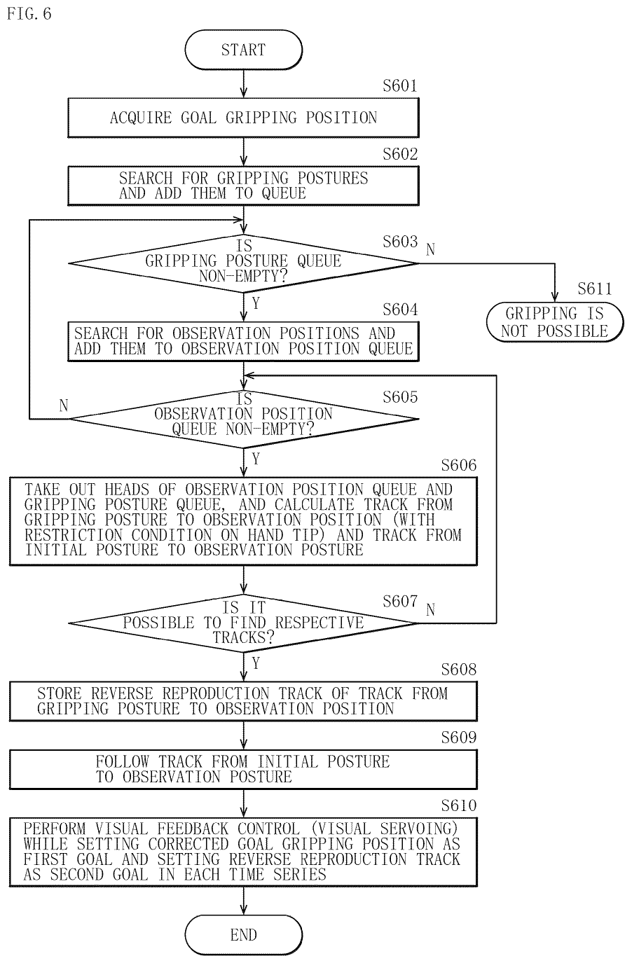

It is to be noted that the gripping posture generation section 53 may search for a plurality of gripping postures, as will be described in a modification example (FIG. 6). In this case, the observation position generation section 54 may search for a plurality of observation positions each corresponding to a corresponding one of the plurality of gripping postures, on the basis of the plurality of gripping postures found by the gripping posture generation section 53. The track generation section 55 may determine whether or not a track from a gripping posture to an observation position and a track from an initial posture of the robot 1 to an observation posture calculated by the observation posture generation section (track generation section 55) are calculable on the basis of the plurality of gripping postures found by the gripping posture generation section 53 and the plurality of observation positions found by the observation position generation section 54 (Step S606 to Step S607 in FIG. 6 to be described later).

The reverse reproduction track storage section 57 is a storage section that stores a reverse reproduction track of the track calculated by the track generation section 55.

The arm control section 56 corresponds to a specific example of a “robot control section” according to the technology of the present disclosure. The arm control section 56 controls a posture of the robot 1 so as to cause the robot 1 to take the observation posture calculated by the observation posture generation section (track generation section 55), causes the robot 1 in the observation posture to observe the gripping target object 100, and then causes the robot 1 to approach the gripping target object 100. For example, the arm control section 56 causes the robot 1 to approach the gripping target object 100 by controlling a position while a first goal is set as the goal gripping position calculated on the basis of a result of observing the gripping target object 100 by the hand camera 31 and a second goal is set as the reverse reproduction track stored in the reverse reproduction track storage section 57.

### 1.2 Behavior

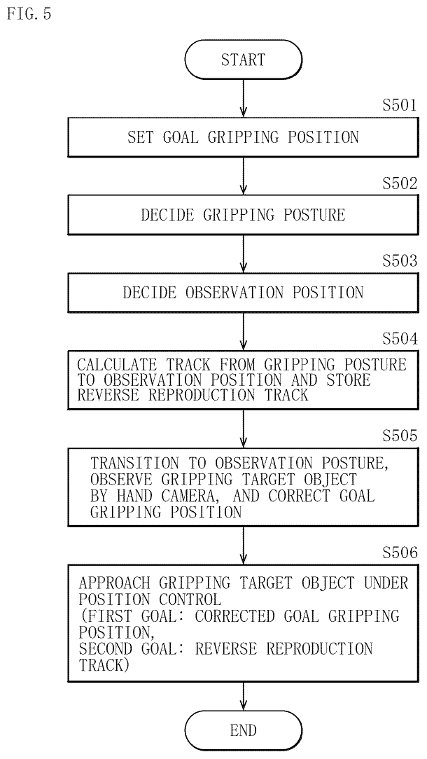

FIG. 5 is a flowchart illustrating an example of the control behavior performed by the robot control device 5 according to the first embodiment.

First, the robot control device 5 sets a goal gripping position (Step S501 and (A) in FIG. 4). The goal gripping position may be autonomously decided by the goal gripping position generation section 51 using a general gripping planning algorithm on the basis of information from the bird's eye view camera 21, or may be designated by a user. It is to be noted that the goal gripping position obtained in this stage does not absorb recognition errors by the bird's eye view camera 21 or mechanistic errors such as ricketiness after movement of the arm 3 and deflection. Therefore, it is assumed the goal gripping position obtained in this stage will be tweaked just before the approach.

Next, the gripping posture generation section 53 of the robot control device 5 decides a gripping posture that satisfies the goal gripping position (Step S502 and (B) in FIG. 4). In a normal behavior flow, the observation position and the observation posture are decided, the robot 1 behaves, and then the gripping posture is decided in many cases. However, according to the technology of the present disclosure, the gripping posture is decided beforehand. It is to be noted that the gripping posture can be found by inverse kinematics calculation or the like. In a way similar to the goal gripping position, there is a possibility that the gripping posture will also be tweaked to obtain a final posture.

Next, the observation position generation section 54 of the robot control device 5 searches for a position (observation position) where it is possible to observe the gripping target object 100 (Step S503 and (C) in FIG. 4). The observation position may be set to a position where it is possible to capture an image of the gripping target object 100 in consideration of the field of view of the hand camera 31. In addition, the observation position may be set to a position where the gripping target object 100 is not hidden behind obstacles around the gripping target object 100 during the observation or to a position where the hand 30 or the arm 3 does not obstruct the field of view of the bird's eye view camera 21 when moving the hand 30, for example.

After the observation position is found, the track generation section 55 of the robot control device 5 calculates a track from the gripping posture to the observation position and stores a reverse reproduction track of the calculated track in the reverse reproduction track storage section 57 (Step S504 and (D) in FIG. 4). It is sufficient to calculate the track by using a general track planning algorithm, but it is desirable to set its speed and acceleration to zero as an initial condition and a termination condition to make it workable even in the reverse reproduction track. In addition, the track may be calculated through kinetics simulation of the track from the gripping posture to the observation position, without using the track planning algorithm.

Subsequently, the arm control section 56 of the robot control device 5 controls the actuators 32 to move the arm 3 from the initial posture to the observation posture, the hand camera 31 observes the gripping target object 100, and the corrected-goal-gripping-position generation section 52 sets a goal gripping position (corrected goal gripping position) corrected relative to the hand camera (Step S505 and (E) in FIG. 4). At this time, the corrected-goal-gripping-position generation section 52 may recognize a positional relation between the bird's eye view camera 21 and the hand camera 31 through point cloud matching or the like and decide the corrected goal gripping position through coordinate transformation based thereon, or may reset the corrected goal gripping position by making a gripping plan on the basis of the information from the hand camera 31 alone. In any way, it is possible to absorb the recognition errors by the bird's eye view camera 21 by setting the corrected goal gripping position of the gripping target object 100 relative to the hand camera more adjacently.

Finally, the arm control section 56 of the robot control device 5 controls the actuators 32, and this causes the robot 1 to approach the gripping target object 100 under the position control (Step S506 and (F) in FIG. 4). Under the position control, the first goal is set to the corrected goal gripping position, and the second goal is set to a joint angle sequence of the reverse reproduction track. It is to be noted that a null space or priority inverse dynamics may be used to control the position while placing priority such as the first goal and the second goal. In addition, if it is assumed that a large amount of correction is necessary for the process in Step S505 ((E) in FIG. 4), a restriction such as normal obstacle avoidance may be imposed on the second goal instead of the reverse reproduction track. Even in such a case, it is possible to reduce a possibility of failure such as collision with an obstacle during the approach or being stuck at joint motion range limit because the appropriate redundant degree of freedom is decided at the stage of the observation posture.

### 1.3. Modification Example

FIG. 6 is a flowchart illustrating a modification example of the control behavior performed by the robot control device 5 according to the first embodiment.

In the modification example, the robot control device 5 determines whether or not it is possible to grip the gripping target object 100 beforehand on the basis of lists of the gripping postures and the observation positions. In addition, to perform visual feedback control (visual servoing) during the approach, a restriction condition is imposed on the hand tip when calculating the track from the gripping posture to the observation position (Step S606 in FIG. 6). It is to be noted that the prior determination on whether or not it is possible to grip the gripping target object 100, and the visual feedback control are independent from each other, and a process using one of them may be adopted in this modification example.

First, the prior determination on whether or not it is possible to grip the gripping target object 100 will be described in detail.

The goal gripping position generation section 51 of the robot control device 5 first acquires a goal gripping position (Step S601). Next, the gripping posture generation section 53 of the robot control device 5 searches for several gripping postures that satisfy the goal gripping position and adds them to a gripping posture queue (Step S602). The gripping postures added to the queue are a plurality of patterns of gripping postures found by leveraging redundancy such as finding the gripping postures while an initial value for the inverse kinematics calculation is set to various joint angles, for example.

Next, the robot control device 5 checks whether or not the gripping posture queue is non-empty (Step S603). In a case where the gripping posture queue is empty (N in Step S603), the robot control device 5 determines that there is no gripping posture that makes it possible to reach the goal gripping position, considers that it is not possible to grip the gripping target object 100, and seeks another way such as moving the position of the dolly 4 (Step S611). It is important that the robot 1 is able to make such a prior determination before behaving. Next, on the contrary, in a case where the gripping posture queue is non-empty (Y in Step S603), the observation position generation section 54 of the robot control device 5 further searches for several observation positions and adds them to an observation position queue (Step S604). Next, the robot control device 5 checks whether or not the observation position queue is non-empty (Step S605). In a case where the observation position queue is empty (N in Step S605), the robot control device 5 returns to the process in Step S603.

Next, in a case where the observation position queue is non-empty (Y in Step S605), the robot control device 5 takes out heads of the observation position queue and the gripping posture queue, and the track generation section 55 finds a track from a gripping posture to an observation position with the restriction condition on the hand tip and a track from an initial posture to an observation posture (Step S606). At this time, the posture (observation posture) at the observation position is also found by planning the track from the gripping posture to the observation position beforehand in the track generation section 55. Next, the track generation section 55 of the robot control device 5 determines whether or not it is possible to calculate the two tracks including the track from the gripping posture to the observation position and the track from the initial posture to the observation posture (Step S607). In a case where it is determined that it is not possible to calculate the two tracks (N in Step S607), the robot control device 5 returns to the process in Step S605. Next, on the contrary, in a case where it is determined that it is possible to calculate the two tracks (Y in Step S607), the robot control device 5 stores a reverse reproduction track of the track from the gripping posture to the observation position in the reverse reproduction track storage section 57 (Step S608). Next, the arm control section 56 of the robot control device 5 controls the actuators 32, and this causes the robot 1 to follow the track from the initial posture to the observation posture (Step S609). Finally, the arm control section 56 of the robot control device 5 controls the actuators 32, thereby performing the visual feedback control (visual servoing) while setting the corrected goal gripping position as the first goal and setting the reverse reproduction track as the second goal in each time series to approach the gripping target object 100 (Step S610). Here, the track and the joint angle are set in units of predetermined time (predetermined steps), and therefore the each time series means a time series in the unit of the predetermined time.

It is to be noted that the queues have been described as representatives of data structures of the lists of gripping postures and observation positions. However, various patterns can be considered such as a priority queue. For example, if using the priority queue in which sorting is performed on the basis of manipulability in the gripping postures and the observation postures at the observation positions, it is possible to generate behaviors in descending order of the manipulability in the gripping posture or the observation posture and check whether or not the behaviors are performable. This makes it possible to obtain a more optimum behavior.

Next, a process related to the visual feedback control will be described.

During the visual feedback control, the control is performed while the hand camera 31 successively corrects the goal gripping position for the approach. To do this, it is basically sufficient to constantly capture an image of the gripping target object 100 when approaching the gripping target object 100. According to the technology of the present disclosure, the robot 1 approaches the gripping target object 100 with reference to the reverse reproduction track of the track from the gripping posture to the observation position. Therefore, the technology of the present disclosure includes the restriction condition on the posture of the hand tip in such a manner that the hand camera 31 constantly captures an image of the gripping target object 100 when planning the track from the gripping posture to the observation position (Step S606 in FIG. 6). This makes it possible to drastically reduce a possibility that a large amount of correction is made on the posture of the hand tip for the approach because the track serving as the second goal for the approach is set to a posture that allows the hand camera 31 to continuously capture an image of the gripping target object 100.

### 1.4 Effects

As described above, the robot control device 5 according to the first embodiment of the present disclosure calculates the observation position and the observation posture on the basis of the gripping posture before approaching the gripping target object 100. This make it possible to reduce a probability that approach to a gripping target object fails.

The robot control device 5 according to the first embodiment performs a process of easily deciding the redundant degree of freedom for approach by calculating the observation position and the observation posture on the basis of the gripping posture. By deciding the observation posture in consideration of the gripping posture, it is possible to reduce a possibility of failure such as collision with an obstacle or failure in reaching the gripping posture due to joint motion range restriction during the approach.

In addition, the robot control device 5 according to the first embodiment performs a process of searching for several patterns of gripping posture and observation position and determining beforehand whether or not to be able to reach the respective postures (FIG. 6). This ensures beforehand that it is possible to reach the gripping posture or the observation posture, and this makes it possible to prevent failures such as a failure in reaching the gripping posture after reaching the observation posture.

In addition, the robot control device 5 according to the first embodiment includes the reverse reproduction track storage section 57 that stores a reverse reproduction track of a found track from the gripping posture to the observation posture, and performs a process of controlling a position while setting the first goal to a position of the gripping target object 100 relative to the hand camera 31 and setting the second goal to the reverse reproduction track during the approach. This makes it possible to decide the redundant degree of freedom by using a track that is guaranteed to satisfy restrictions such as avoidance of collision with obstacles during approach or the joint motion range. Therefore, it is possible to decide an appropriate redundant degree of freedom that satisfies the restrictions in the control loop without high-load behavior planning.

In addition, the robot control device 5 according to the first embodiment performs the process of searching for the observation position or searching for the track from the gripping posture to the observation posture by calculating a position where the gripping target object 100 is included in the field of view of the hand camera 31. This ensures that it is possible to capture an image of the gripping target object 100 in the field of view of the visual sensor at the start of and during the approach, and this makes it possible to perform the visual feedback control from the observation position to the goal gripping position (Step S610 in FIG. 6).

It is to be noted that the effects described herein are only for illustrative purposes and there may be other effects. The same applies to effects according to other embodiments to be described below.

### 2. Other Embodiments

The technology according to the present disclosure is not limited to the above-described embodiment, and various kinds of modifications thereof can be made.

For example, the present technology may be configured as follows. According to the present technology having the following configurations, it is possible to calculate the observation position and the observation posture on the basis of the gripping posture before approaching the gripping target object 100. This make it possible to reduce a probability that approach to the gripping target object fails.
(1)
A robot control device including:
a gripping posture generation section that calculates a gripping posture to be taken upon gripping a gripping target object with a hand of a robot;
an observation position generation section that calculates an observation position where the gripping target object is observable by the robot on the basis of the gripping posture calculated by the gripping posture generation section;
an observation posture generation section that calculates an observation posture of the robot at the observation position on the basis of the gripping posture calculated by the gripping posture generation section and the observation position calculated by the observation position generation section; and
a robot control section that controls a posture of the robot to cause the robot to take the observation posture calculated by the observation posture generation section, causes the robot in the observation posture to observe the gripping target object, and then causes the robot to approach the gripping target object.
(2)
The robot control device according to (1), in which the gripping posture generation section calculates the gripping posture on the basis of sensor information from a first sensor provided on the robot.
(3)
The robot control device according to (1) or (2), in which, as the observation position, the observation position generation section searches for a position where the gripping target object is observable by a second sensor, the second sensor being provided on the hand of the robot.
(4)
The robot control device according to any one of (1) to (3), in which
the gripping posture generation section searches for a plurality of the gripping postures, and
the observation position generation section searches for a plurality of the observation positions each corresponding to a corresponding one of the plurality of gripping postures, on the basis of the plurality of gripping postures found by the gripping posture generation section.
(5)
The robot control device according to (4), further including a track generation section that determines whether or not a track from the gripping posture to the observation position and a track from an initial posture of the robot to the observation posture calculated by the observation posture generation section are calculable on the basis of the plurality of gripping postures found by the gripping posture generation section and the plurality of observation positions found by the observation position generation section.
(6)
The robot control device according to any one of (1) to (5), further including:
a track generation section that calculates a track from the gripping posture calculated by the gripping posture generation section to the observation position calculated by the observation position generation section; and
a storage section that stores a reverse reproduction track of the track calculated by the track generation section.
(7)
The robot control device according to (6), in which the robot control section causes the robot to approach the gripping target object by controlling a position while a first goal is set as a goal gripping position calculated on the basis of a result of observing the gripping target object by a second sensor provided on the hand of the robot and a second goal is set as the reverse reproduction track stored in the storage section.
(8)
The robot control device according to (1) or (2), in which
the observation position generation section calculates an observation position where the gripping target object is observable by a second sensor, the second sensor being provided on the hand of the robot, and
as the track from the gripping posture to the observation position, the track generation section calculates a track that allows the second sensor to continuously observe the gripping target object from the gripping posture to the observation position.

The robot control device according to (6) or (7)
(9)
A robot control method including:
calculating a gripping posture to be taken upon gripping a gripping target object with a hand of a robot;
calculating an observation position where the gripping target object is observable by the robot on the basis of the calculated gripping posture;
calculating an observation posture of the robot at the observation position on the basis of the calculated gripping posture and the calculated observation position; and
controlling a posture of the robot to cause the robot to take the calculated observation posture, causing the robot in the observation posture to observe the gripping target object, and then causing the robot to approach the gripping target object.

The present application claims the benefit of Japanese Priority Patent Application JP2021-110817 filed with the Japan Patent Office on Jul. 2, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

1. A robot control device comprising:
a gripping posture generation section that calculates a gripping posture to be taken upon gripping a gripping target object with a hand of a robot;
an observation position generation section that calculates an observation position where the gripping target object is observable by the robot on a basis of the gripping posture calculated by the gripping posture generation section;
an observation posture generation section that calculates an observation posture of the robot at the observation position on a basis of the gripping posture calculated by the gripping posture generation section and the observation position calculated by the observation position generation section; and
a robot control section that controls a posture of the robot to cause the robot to take the observation posture calculated by the observation posture generation section, causes the robot in the observation posture to observe the gripping target object, and then causes the robot to approach the gripping target object.

2. The robot control device according to claim 1, wherein the gripping posture generation section calculates the gripping posture on a basis of sensor information from a first sensor provided on the robot.

3. The robot control device according to claim 1, wherein, as the observation position, the observation position generation section searches for a position where the gripping target object is observable by a second sensor, the second sensor being provided on the hand of the robot.

4. The robot control device according to claim 1, wherein
the gripping posture generation section searches for a plurality of the gripping postures, and
the observation position generation section searches for a plurality of the observation positions each corresponding to a corresponding one of the plurality of gripping postures, on a basis of the plurality of gripping postures found by the gripping posture generation section.

5. The robot control device according to claim 4, further comprising a track generation section that determines whether or not a track from the gripping posture to the observation position and a track from an initial posture of the robot to the observation posture calculated by the observation posture generation section are calculable on a basis of the plurality of gripping postures found by the gripping posture generation section and the plurality of observation positions found by the observation position generation section.

6. The robot control device according to claim 1, further comprising:
a track generation section that calculates a track from the gripping posture calculated by the gripping posture generation section to the observation position calculated by the observation position generation section; and
a storage section that stores a reverse reproduction track of the track calculated by the track generation section.

7. The robot control device according to claim 6 wherein the robot control section causes the robot to approach the gripping target object by controlling a position while a first goal is set as a goal gripping position calculated on a basis of a result of observing the gripping target object by a second sensor provided on the hand of the robot and a second goal is set as the reverse reproduction track stored in the storage section.

8. The robot control device according to claim 6, wherein
the observation position generation section calculates an observation position where the gripping target object is observable by a second sensor, the second sensor being provided on the hand of the robot, and
as the track from the gripping posture to the observation position, the track generation section calculates a track that allows the second sensor to continuously observe the gripping target object from the gripping posture to the observation position.

9. A robot control method comprising:
calculating a gripping posture to be taken upon gripping a gripping target object with a hand of a robot;
calculating an observation position where the gripping target object is observable by the robot on a basis of the calculated gripping posture;
calculating an observation posture of the robot at the observation position on a basis of the calculated gripping posture and the calculated observation position; and
controlling a posture of the robot to cause the robot to take the calculated observation posture, causing the robot in the observation posture to observe the gripping target object, and then causing the robot to approach the gripping target object.
